(19) United States
(12) Patent Application Publication
(10) Pub. No.: US 2026/0217299 A1
(43) Pub. Date: Jul. 30, 2026

(54) STEERING DEVICE

(71) Applicant: TOYODA GOSEI CO., LTD., Kiyosu-shi, Aichi-ken (JP)

(72) Inventor: Rie Ono, Kiyosu-shi, Aichi-ken (JP)

(21) Appl. No.: 19/032,808

(22) Filed: Jan. 21, 2025

(30) Foreign Application Priority Data
Mar. 26, 2024 (JP) 2024-050381

(51) Int. Cl. B62D 1/06

(52) U.S. Cl. CPC B62D 1/06; B62D 1/065

(57) ABSTRACT

A steering device mounted on a vehicle, the steering device including:

a grip portion gripped by a driver during steering;

a heater layer provided inside the grip portion, the heater layer including a flexible base material and carbon nanotubes that are supported on the base material and generate heat by energization; and

an electrode portion that energizes the carbon nanotubes,

wherein the carbon nanotubes on the base material include a plurality of openings.

### CROSS-REFERENCE TO RELATED APPLICATIONS

The present application claims priority from Japanese Patent Application No. 2024-050381 of Ono, filed on March 26, 2024, the disclosures of which are hereby incorporated into the present application by reference.

### BACKGROUND

### TECHNICAL FIELD

The present invention relates to a steering device including a heating element inside a grip portion that is gripped by a driver.

### DESCRIPTION OF RELATED ART

As a conventional measure against coldness in winter, as disclosed in JP 2018-002101 A, a configuration is known in which a heater layer including a heating element that generates heat by energization is provided inside a grip portion, gripped by a driver, in a steering wheel as a steering device. The heating element disclosed in JP 2018-002101 A includes a metal heater wire provided on a resin base material.

Carbon nanotubes are lightweight materials with excellent electrical and thermal conductivity and far-infrared radiation heat effects, and therefore, a configuration using carbon nanotubes as a heating element instead of metal is conceivable. However, carbon nanotubes are hard materials. Thus, in a case where carbon nanotubes are simply supported uniformly on a base material and assembled onto the grip portion, deterioration in the ease of assembly of the heating element may occur, such as cracking of carbon nanotubes when the base material is bent to conform to the curved surface of the grip portion.

### SUMMARY

An object of the present invention is to provide a steering device capable of suppressing deterioration in the ease of assembly of a heating element while using carbon nanotubes as the heating element.

A typical configuration of the steering device according to the present invention is as follows:

A steering device mounted on a vehicle includes: a grip portion gripped by a driver during steering; a heater layer provided inside the grip portion, the heater layer including a flexible base material and carbon nanotubes that are supported on the base material and generate heat by energization; and an electrode portion that energizes the carbon nanotubes, wherein the carbon nanotubes on the base material include a plurality of openings.

### BRIEF DESCRIPTION OF THE DRAWINGS

FIG. 1 is a view of the surroundings of a driver’s seat in a vehicle equipped with a steering wheel, as viewed from the left side.

FIG. 2 is a front view of the steering wheel.

FIG. 3 is a cross-sectional view of the grip portion of the steering wheel.

FIG. 4 is a perspective schematic view of the heater layer of the grip portion.

FIG. 5 is a developed view of the heater layer developed in a flattened state.

FIGS. 6A and 6B are cross-sectional views of the heater layer.

FIG. 7 is a developed view of the heater layer developed in a flattened state.

FIGS. 8A and 8B are cross-sectional views of the heater layer.

### DESCRIPTION OF THE PREFERRED EMBODIMENTS

Preferred embodiments of the present invention are described below with reference to accompanying drawings. However, the invention is not limited to the embodiments disclosed herein. All modifications within the appended claims and equivalents relative thereto are intended to be encompassed in the scope of the claims.

### First Embodiment

Hereinafter, a steering device according to a first embodiment of the present invention will be described with reference to the drawings. Note that the dimensions, materials, shapes, relative arrangements, and the like of components described below are not intended to limit the scope of the present invention, unless otherwise specified.

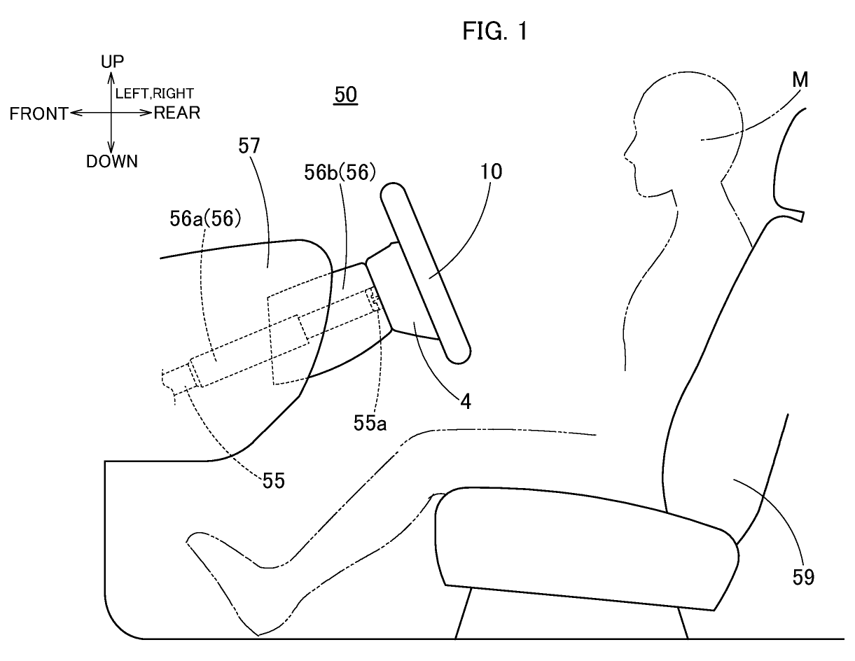

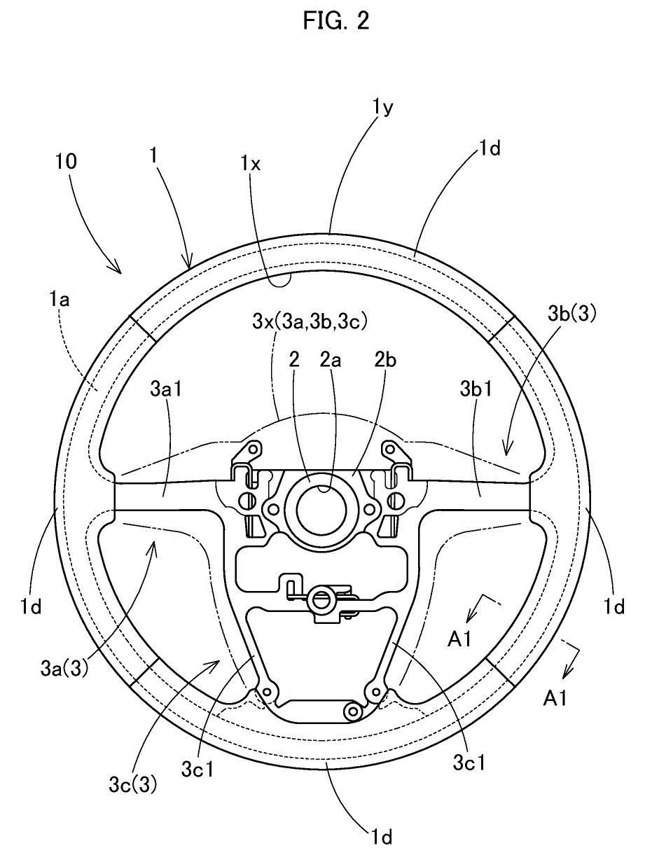

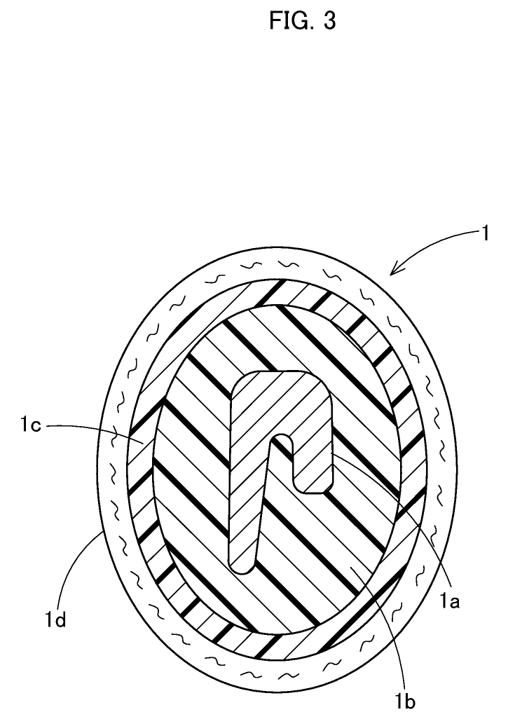

FIG. 1 is a view of the surroundings of a driver’s seat 59 in a vehicle 50 equipped with a steering wheel 10 as a steering device, as viewed from the left side, and illustrates a driver M seated on the driver’s seat 59 by a two-dot dash line. FIG. 2 is a front view of the steering wheel 10, with an upper cover 3x made transparent to facilitate viewing of the internal configuration, and with only the outline indicated by two-dot dash lines. FIG. 3 is a cross-sectional view of a grip portion 1 of the steering wheel 10 taken along line A1-A1 in FIG. 2.

In the following description, unless otherwise specified, each direction described with respect to the steering wheel 10 means a direction in a state where the steering wheel 10 is mounted on the vehicle 50 illustrated in FIG. 1. That is, the left-right direction means the left direction and the right direction of the vehicle 50 equipped with the steering wheel 10, specifically, the left direction and the right direction as viewed from the driver M. The front-rear direction substantially coincides with the front direction and the rear direction of the vehicle 50, specifically, the front direction and the rear direction as viewed from the driver M. The up-down direction substantially coincides with the vertically upward direction and the vertically downward direction.

As illustrated in FIG. 1, the steering wheel 10 is mounted on the vehicle 50 by being coupled to a steering shaft 55 of the vehicle 50. In the present embodiment, the vehicle 50 is an automobile. The vehicle 50 includes a steering column 56 including a column tube 56a that partially covers the outer periphery of the steering shaft 55 to support the steering shaft 55, and a column cover 56b that covers a portion of the steering shaft 55 protruding rearward from an instrument panel 57. The steering wheel 10 is attached to a rear end 55a of the steering shaft 55 protruding rearward from the instrument panel 57.

As illustrated in FIGS. 2 and 3, the steering wheel 10 includes a grip portion 1 gripped by the driver M when the vehicle 50 is steered, a hub portion 2 disposed inside the grip portion 1 and coupled to the steering shaft 55, and a spoke portion 3 that couples the grip portion 1 and the hub portion 2. A lower cover 4 is provided on the front side of the steering wheel 10 (cf. FIG. 1).

The grip portion 1 is a portion also referred to as a rim portion, and has an annular shape in the present embodiment, but may have another shape. The driver grips the grip portion 1 and rotationally steers the grip portion 1 around the steering shaft 55 to change the travel direction of the vehicle 50.

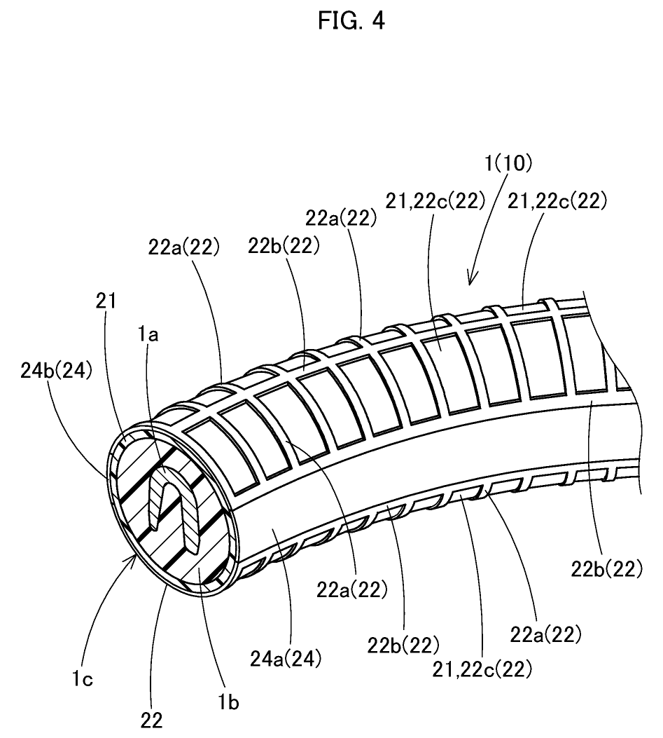

The grip portion 1 is formed by laminating, onto a metal core material 1a formed of an aluminum alloy or the like: a coating layer 1b made of a material with cushioning properties such as foamed polyurethane; a heater layer 1c including carbon nanotubes 22 (cf. FIG. 4) as a heating element that generates heat by energization; and a skin layer 1d disposed on the outermost surface of the grip portion 1.

The skin layer 1d is divided into four parts in the rotational direction of the grip portion 1, and then bonded to the outer periphery of the heater layer 1c with an adhesive (not illustrated). The skin layer 1d is formed of insulating leather, resin, or the like, and protects the driver M who grips the grip portion 1 from a current when the carbon nanotubes 22 are energized. A detailed configuration of the heater layer 1c will be described later.

The hub portion 2 is a metal member coupled to the steering shaft 55, and includes a shaft hole 2a through which the steering shaft 55 is inserted. The hub portion 2 and the steering shaft 55 are coupled by fastening the rear end 55a of the steering shaft 55 with a nut while the rear end 55a is inserted through the shaft hole 2a and fitted thereto. The hub portion 2 is integrally molded with a metal core material 2b.

The spoke portion 3 includes a left spoke portion 3a and a right spoke portion 3b extending from the hub portion 2 to the left and right, respectively, and a lower spoke portion 3c extending downward. The left spoke portion 3a and the right spoke portion 3b include metal core materials 3a1, 3b1 extending left and right, respectively, to connect the core material 1a of the grip portion 1 and the core material 2b of the hub portion 2. The lower spoke portion 3c includes a metal core material 3c1 extending downward from the core material 2b of the hub portion 2 and connected to the core material 1a of the grip portion 1 while branching to the left and right. The left spoke portion 3a, the right spoke portion 3b, and the lower spoke portion 3c include a resin upper cover 3x covering the core materials 3a1, 3b1, 3c1.

Here, the core material 1a of the grip portion 1, the core material 2b of the hub portion 2, and the core materials 3a1, 3b1, 3c1 of the spoke portion 3 are integrally molded by die casting, whereby the grip portion 1, the hub portion 2, and the spoke portion 3 are coupled. However, the core material 1a of the grip portion 1, the core material 2b of the hub portion 2, and the core materials 3a1, 3b1, 3c1 of the spoke portion 3 may be separately formed and coupled by welding or the like.

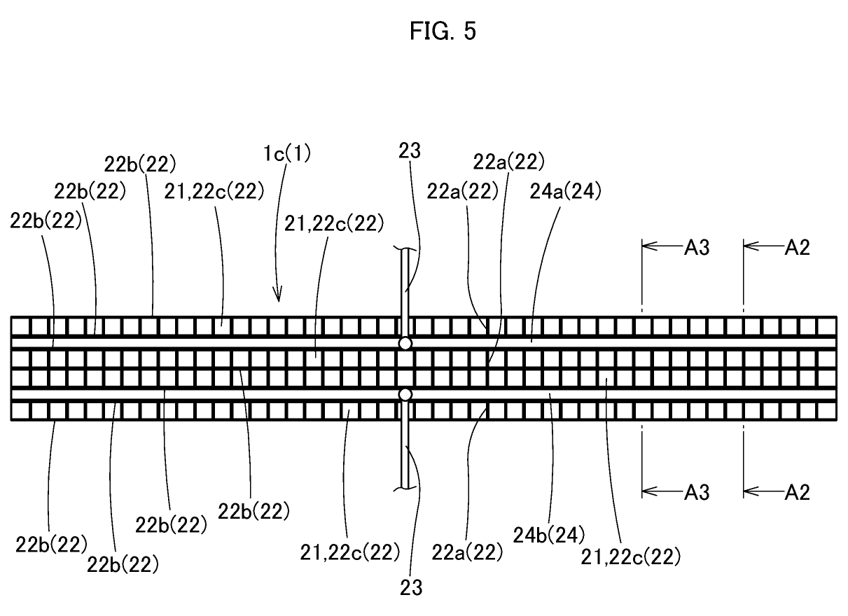

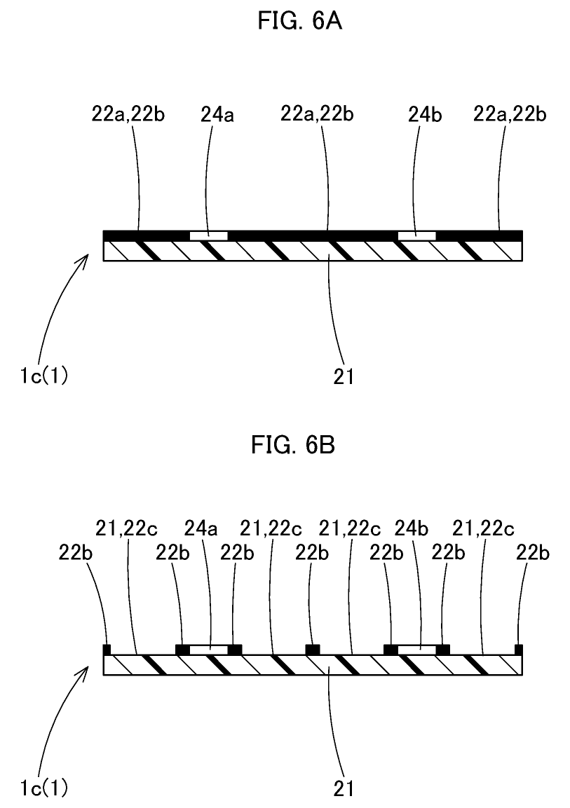

Next, a detailed configuration of the heater layer 1c will be described. FIG. 4 is a perspective schematic view of the heater layer 1c. FIG. 5 is a developed view of the heater layer 1c developed in a flattened state. FIG. 6A is a cross-sectional view of the heater layer 1c taken along line A2-A2 illustrated in FIG. 5. FIG. 6B is a cross-sectional view of the heater layer 1c taken along line A3-A3 illustrated in FIG. 5.

As illustrated in FIGS. 4, 5, 6A, and 6B, the heater layer 1c includes a flexible base material 21, carbon nanotubes 22 supported on the base material 21, and an electrode portion 24 disposed around the carbon nanotubes 22 on the base material 21.

The base material 21 is a flexible sheet-like member and is attached to the outer periphery of the coating layer 1b with an adhesive. In the present embodiment, the base material 21 is formed of a polyester-based film, but another configuration may be used as long as flexibility is provided. As another configuration of the base material 21, for example, a hot melt film, a urethane elastomer-based sheet such as TPU, an acrylic resin-based tape, or the like is used.

The electrode portion 24 is formed of a strip-shaped metal foil, and is bonded to the base material 21 with an adhesive or the like to be held on the base material 21. The electrode portion 24 includes an anode 24a disposed on an inner periphery 1x (FIG. 2) side of the grip portion 1 over the entire region in the rotational direction of the grip portion 1 and a cathode 24b disposed on an outer periphery 1y (FIG. 2) side of the grip portion 1 over the entire region in the rotational direction of the grip portion 1. That is, the anode 24a and the cathode 24b of the electrode portion 24 are arranged alongside each other in the circumferential direction of the grip portion 1. A lead wire 23 electrically connected to a control device (not illustrated) is connected to each of the anode 24a and the cathode 24b. Here, the circumferential direction of the grip portion 1 refers to the direction in which the driver M hangs fingers when gripping the grip portion 1, and the rotational direction refers to the direction in which the grip portion 1 moves when the steering wheel 10 is rotationally steered.

The carbon nanotubes 22 are supported on the base material 21 by being thermally transferred to the surface of the base material 21. In the present embodiment, the thermal transfer sheet used for thermal transfer is formed by printing a dispersion liquid containing about 5% by weight of the carbon nanotubes 22 onto the sheet in a pattern that will be described later. Note that the method for supporting the carbon nanotubes 22 on the base material 21 is not limited thereto, and for example, a dispersion liquid in which the carbon nanotubes 22 are dispersed may be applied onto the base material 21 and supported, or may be supported by screen printing or inkjet printing.

The carbon nanotubes 22 on the base material 21 include a plurality of horizontal linear portions 22a (first linear portions) extending linearly along the circumferential direction of the grip portion 1 and a plurality of vertical linear portions 22b (second linear portions) extending linearly along the rotational direction of the grip portion 1. The horizontal linear portions 22a are arranged at intervals along the rotational direction of the grip portion 1. The vertical linear portions 22b are orthogonal to (intersect with) the horizontal linear portions 22a and are arranged at intervals along the circumferential direction of the grip portion 1. That is, the carbon nanotubes 22 on the base material 21 are arranged in a lattice form with the horizontal linear portions 22a and the vertical linear portions 22b. In the present embodiment, the carbon nanotubes 22 arranged in the lattice form are provided over the entire region on the base material 21, except for the portion where the electrode portion 24 is disposed. In FIG. 5, the longitudinal direction of the base material 21 corresponds to the rotational direction of the grip portion 1, and the lateral direction of the base material 21 corresponds to the circumferential direction of the grip portion 1.

In addition, a region surrounded by the horizontal linear portions 22a and the vertical linear portions 22b in the carbon nanotubes 22 on the base material 21 constitutes an opening 22c in the carbon nanotubes 22 that opens so that the base material 21 is exposed. The opening 22c is formed in the carbon nanotubes 22 on the base material 21, and can also be said to be a through hole penetrating in the thickness direction of the base material 21 so that the base material 21 is exposed. A plurality of openings 22c are provided in the carbon nanotubes 22. In the present embodiment, since the horizontal linear portion 22a and the vertical linear portion 22b are orthogonal to each other, the opening 22c has a quadrangular shape, and the opening area of the opening 22c is set to 10mm² or less.

To raise the temperature of the grip portion 1, the driver M first operates a switch (not illustrated) mounted on the vehicle 50. In response to this, the control device controls a power source (not illustrated) mounted on the vehicle 50 to apply a voltage to the electrode portion 24. This allows a current to flow between the anode 24a and the cathode 24b of the electrode portion 24, and the carbon nanotubes 22 are energized to generate heat, raising the temperature of the grip portion 1. In this manner, the hands of the driver M who grips the grip portion 1 are warmed.

As described above, in the heater layer 1c, the carbon nanotubes 22 on the base material 21 include the plurality of openings 22c, thereby achieving the following effects. That is, the carbon nanotubes 22 are lightweight materials with excellent electrical and thermal conductivity and far-infrared radiation heat effects. Meanwhile, the carbon nanotubes 22 are hard materials. Thus, in a case where the carbon nanotubes 22 are simply supported uniformly on the base material 21 and assembled onto the grip portion 1 to use the carbon nanotubes 22 as the heating element, deterioration in the ease of assembly of the heating element may occur, such as cracking of the carbon nanotubes 22 when the base material 21 is bent to conform to the curved surface of the grip portion 1.

On the other hand, in the present embodiment, the carbon nanotubes 22 are supported on the flexible base material 21, and the plurality of openings 22c are provided in the carbon nanotubes 22. This facilitates the conformity of the base material 21 to the curved surface of the grip portion 1 by utilizing the flexibility of the portion on the base material 21, which does not support the carbon nanotubes 22 and corresponds to the opening 22c, and facilitates the assembly of the carbon nanotubes 22 onto the grip portion 1. Therefore, according to the steering wheel 10 of the present embodiment, it is possible to suppress deterioration in the ease of assembly of the heating element while using the carbon nanotubes 22 as the heating element.

The vertical linear portion 22b of the carbon nanotubes 22 is disposed at each end of the anode 24a in the circumferential direction of the grip portion 1. Similarly, the vertical linear portion 22b of the carbon nanotubes 22 is disposed at each end of the cathode 24b in the circumferential direction of the grip portion 1. With such a configuration, a large contact area between the electrode portion 24 and the carbon nanotubes 22 can be ensured, enabling a stable electrical connection between the electrode portion 24 and the carbon nanotubes 22.

The anode 24a and the cathode 24b of the electrode portion 24 are arranged alongside each other in the circumferential direction of the grip portion 1. With such a configuration, the electrode portion 24 can be disposed throughout the steering wheel 10 in the rotational direction when the steering wheel 10 is viewed from the front, thereby warming the steering wheel 10 uniformly. In addition, since the distance between the anode 24a and the cathode 24b is shortened, excellent temperature rise characteristics and uniform heat generation can be achieved even at a low voltage. If this is not taken into consideration, the anode 24a and the cathode 24b may be arranged alongside each other in the rotational direction of the grip portion 1.

In the present embodiment, the configuration has been described in which the carbon nanotubes 22 on the base material 21 include the plurality of horizontal linear portions 22a and the plurality of vertical linear portions 22b, and these portions are orthogonal to each other. However, the present invention is not limited thereto. That is, the pattern of the carbon nanotubes 22 on the base material 21 is arbitrary, and the same effect as described above can be obtained as long as the carbon nanotubes 22 include at least a plurality of openings 22c. For example, the carbon nanotubes 22 on the base material 21 may include only one set of the plurality of horizontal linear portions 22a or the plurality of vertical linear portions 22b. The horizontal linear portion 22a and the vertical linear portion 22b are not necessarily orthogonal to each other, and the opening 22c may have another shape.

However, if the carbon nanotubes 22 include the plurality of horizontal linear portions 22a and the plurality of vertical linear portions 22b as in the present embodiment, this configuration is preferable because the carbon nanotubes 22 can be easily placed over the entire region of the grip portion 1 while the plurality of openings 22c are formed in the carbon nanotubes 22, facilitating a uniform temperature rise across the entire grip portion 1. When the carbon nanotubes 22 on the base material 21 include only the plurality of vertical linear portions 22b, the anode 24a and the cathode 24b of the electrode portion 24 may be arranged alongside each other in the rotational direction of the grip portion 1.

### Second Embodiment

Next, a steering device according to a second embodiment of the present invention will be described. Portions that would otherwise be described in the same manner as in the first embodiment will be denoted by the same reference numerals, and their description will be omitted.

The steering wheel 10 as the steering device of the present embodiment differs from the steering wheel 10 of the first embodiment only in the arrangement of the carbon nanotubes 22 on the base material 21 of the heater layer 1c. Other configurations of the steering wheel 10 according to the present embodiment are the same as the configurations of the first embodiment, including the configurations of the base material 21 and the electrode portion 24 of the heater layer 1c and the configuration of the vehicle 50 equipped with the steering wheel 10. Therefore, the detailed description of these configurations is simplified or omitted.

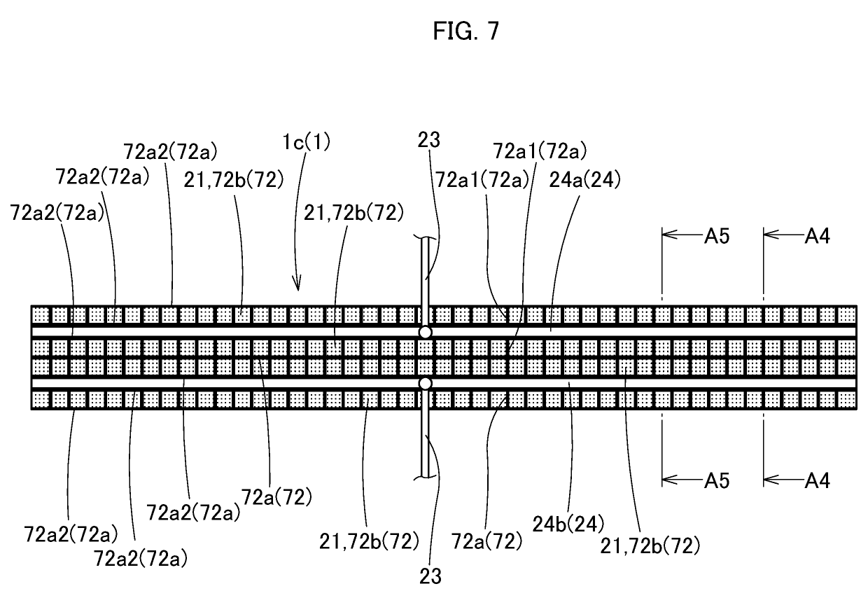

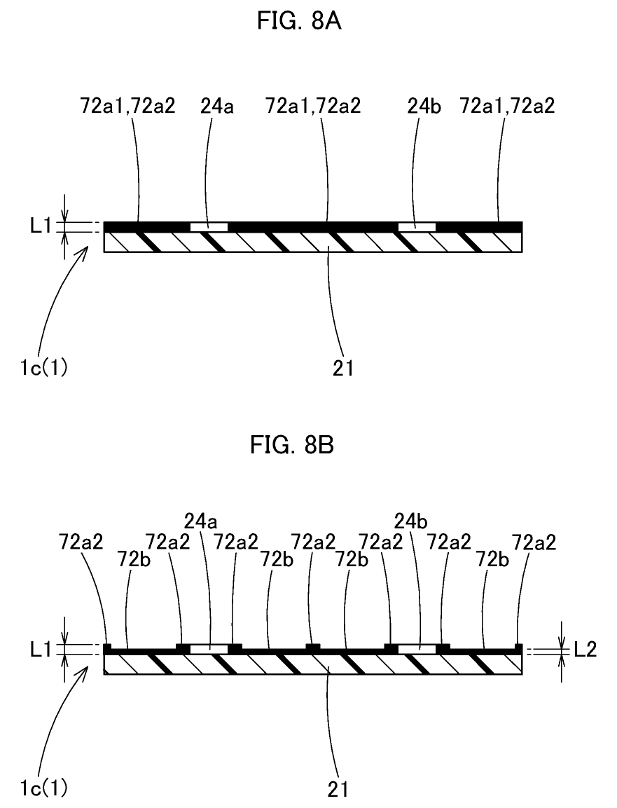

FIG. 7 is a developed view of the heater layer 1c according to the present embodiment developed in a flattened state. FIG. 8A is a cross-sectional view of the heater layer 1c taken along line A4-A4 illustrated in FIG. 7. FIG. 8B is a cross-sectional view of the heater layer 1c taken along line A5-A5 illustrated in FIG. 7.

As illustrated in FIGS. 7, 8A, and 8B, the heater layer 1c of the present embodiment includes a flexible base material 21, carbon nanotubes 72 supported on the base material 21, and an electrode portion 24 disposed around the carbon nanotubes 72 on the base material 21. The base material 21 is a flexible sheet-like member and is attached to the outer periphery of the coating layer 1b with an adhesive.

The electrode portion 24 is formed of a strip-shaped metal foil, and is bonded to the base material 21 with an adhesive or the like to be held on the base material 21. The electrode portion 24 includes an anode 24a disposed on the inner periphery 1x side of the grip portion 1 over the entire region in the rotational direction of the grip portion 1 and a cathode 24b disposed on the outer periphery 1y side of the grip portion 1 over the entire region in the rotational direction of the grip portion 1. That is, the anode 24a and the cathode 24b of the electrode portion 24 are arranged alongside each other in the circumferential direction of the grip portion 1. A lead wire 23 electrically connected to a control device (not illustrated) is connected to each of the anode 24a and the cathode 24b.

The carbon nanotubes 72 are supported on the base material 21 by being thermally transferred to the surface of the base material 21. In the present embodiment, the thermal transfer sheet used for thermal transfer is formed by printing a dispersion liquid containing about 5% by weight of the carbon nanotubes 72 onto the sheet in a pattern that will be described later. Note that the method for supporting the carbon nanotubes 72 on the base material 21 is not limited thereto, and for example, a dispersion liquid in which the carbon nanotubes 72 are dispersed may be applied onto the base material 21.

The carbon nanotubes 72 on the base material 21 includes a thick portion 72a (first region) having a thickness L1 and a thin portion 72b (second region) having a thickness L2 thinner than the thick portion 72a. The thick portion 72a includes a plurality of horizontal linear portions 72a1 (first linear portions) extending linearly along the circumferential direction of the grip portion 1 and a plurality of vertical linear portions 72a2 (second linear portions) extending linearly along the rotational direction of the grip portion 1. The horizontal linear portions 72a1 are arranged at intervals along the rotational direction of the grip portion 1. The vertical linear portions 72a2 are orthogonal to (intersect with) the horizontal linear portions 72a1 and are arranged at intervals along the circumferential direction of the grip portion 1. That is, the thick portion 72a is disposed in a lattice form with the horizontal linear portions 72a1 and the vertical linear portions 72a2. The thick portion 72a disposed in the lattice form is provided over the entire region on the base material 21, except for the portion where the electrode portion 24 is disposed and the portion where the thin portion 72b is disposed. In FIG. 7, the longitudinal direction of the base material 21 corresponds to the rotational direction of the grip portion 1, and the lateral direction of the base material 21 corresponds to the circumferential direction of the grip portion 1.

The thin portion 72b is disposed in a region surrounded by the horizontal linear portions 72a1 and the vertical linear portions 72a2 of the thick portion 72a in the carbon nanotubes 72 on the base material 21. That is, the thin portion 72b is sandwiched between the plurality of horizontal linear portions 72a1 arranged at intervals along the rotational direction of the grip portion 1. Similarly, the thin portion 72b is sandwiched between the plurality of vertical linear portions 72a2 arranged at intervals along the circumferential direction of the grip portion 1. In the present embodiment, since the horizontal linear portion 72a1 and the vertical linear portion 72a2 of the thick portion 72a are orthogonal to each other, the thin portion 72b has a quadrangular shape.

To raise the temperature of the grip portion 1, the driver M first operates a switch (not illustrated) mounted on the vehicle 50. In response to this, the control device controls a power source (not illustrated) mounted on the vehicle 50 to apply a voltage to the electrode portion 24. This allows a current to flow between the anode 24a and the cathode 24b of the electrode portion 24, and the carbon nanotubes 72 are energized to generate heat, raising the temperature of the grip portion 1. In this manner, the hands of the driver M who grips the grip portion 1 are warmed.

As described above, in the heater layer 1c, the carbon nanotubes 72 on the base material 21 include the thick portion 72a and the thin portion 72b, thereby achieving the following effects. That is, the amount of the carbon nanotubes 72 on the portion of the base material 21 supporting the thin portion 72b is smaller than the amount of the carbon nanotubes 72 on the portion supporting the thick portion 72a. This makes the portion of the base material 21 supporting the thin portion 72b easier to bend than the portion of the base material 21 supporting the thick portion 72a. Thus, by including the thick portion 72a and the thin portion 72b in the carbon nanotubes 72 on the base material 21, the base material 21 can be easily conformed to the curved surface of the grip portion 1 by utilizing the flexibility of the portion on the base material 21 that supports the thin portion 72b. This facilitates the assembly of the carbon nanotubes 72 onto the grip portion 1 compared to a configuration in which the carbon nanotubes 72 are supported on the base material 21 with a uniform thickness. Therefore, according to the steering wheel 10 of the present embodiment, it is possible to suppress deterioration in the ease of assembly of the heating element while using the carbon nanotubes 72 as the heating element.

The vertical linear portion 72a2 of the thick portion 72a of the carbon nanotubes 72 is disposed at each end of the anode 24a in the circumferential direction of the grip portion 1. Similarly, the vertical linear portion 72a2 of the thick portion 72a of the carbon nanotubes 72 is disposed at each end of the cathode 24b in the circumferential direction of the grip portion 1. With such a configuration, a large contact area between the electrode portion 24 and the carbon nanotubes 72 can be ensured, enabling a stable electrical connection between the electrode portion 24 and the carbon nanotubes 22.

The anode 24a and the cathode 24b of the electrode portion 24 are arranged alongside each other in the circumferential direction of the grip portion 1. With such a configuration, the electrode portion 24 can be disposed throughout the steering wheel 10 in the rotational direction when the steering wheel 10 is viewed from the front, thereby warming the steering wheel 10 uniformly. In addition, since the distance between the anode 24a and the cathode 24b is shortened, excellent temperature rise characteristics and uniform heat generation can be achieved even at a low voltage. If this is not taken into consideration, the anode 24a and the cathode 24b may be arranged alongside each other in the rotational direction of the grip portion 1.

In the present embodiment, the thick portion 72a includes the horizontal linear portion 72a1 and the vertical linear portion 72a2, and these portions are orthogonal to each other. However, the present invention is not limited thereto. That is, the pattern of the carbon nanotubes 72 on the base material 21 is arbitrary, and the same effect as described above can be obtained as long as the carbon nanotubes 72 include the thick portion 72a and the thin portion 72b. The thicknesses of the carbon nanotubes 72 may be divided into three or more types according to the shape of the grip portion 1 and the like, instead of the two types of thicknesses L1, L2.

In addition, in the configuration of the present embodiment, the carbon nanotubes 72 do not include an opening like the opening 22c in the carbon nanotubes 22 of the first embodiment but include the thick portion 72a and the thin portion 72b, which makes it easier to uniformly warm the entire grip portion 1 compared to the configuration of the first embodiment. On the other hand, in the configuration of the first embodiment, because the carbon nanotubes 22 include the opening 22c, the base material 21 bends more easily, resulting in greater ease of assembly onto the grip portion 1 compared to the configuration of the second embodiment. Therefore, to make use of the advantages of both configurations, the advantages of both configurations, the configuration of the first embodiment and the configuration of the second embodiment may be combined according to the shape of the grip portion 1 and the portion requiring temperature rise, and the carbon nanotubes on the base material 21 may include the opening, the thick portion, and the thin portion as described above. In the configuration of the first embodiment, the second embodiment, or the combination thereof, a cut extending in the circumferential direction of the grip portion 1 may be formed in the base material 21 to facilitate the conformity of the base material 21 to the outer periphery of the coating layer 1b.

In the first embodiment and the second embodiment, the configuration has been described in which the carbon nanotubes 22, 72 supported on the base material 21 is used as the heating element that warms the hands of the driver M who grips the grip portion 1. However, the present invention is not limited thereto, and the carbon nanotubes 22, 72 may be used as a sensor electrode of a capacitance grip sensor that detects the gripping of the grip portion 1 by the driver M. Even with such a configuration, similarly to the configuration in which the carbon nanotubes 22, 72 are used as the heating element described above, deterioration in the ease of assembly of the sensor electrode onto the grip portion 1 can be suppressed.

In the first embodiment and the second embodiment, the configuration in which the carbon nanotubes 22, 72 are supported on the base material 21 and assembled onto the grip portion 1 has been described, but the present invention is not limited thereto. That is, it is not always necessary to provide the base material 21 when the carbon nanotubes 22, 72 are assembled onto the grip portion 1, and for example, the carbon nanotubes 22, 72 may be supported on the outer periphery of the coating layer 1b by in-mold molding, roll transfer, thermal transfer, or the like. In this case, the carbon nanotubes 22 and the electrode portion 24 are disposed as in the first embodiment, and the plurality of openings 22c are provided in the carbon nanotubes 22, so that the same effect as described above can be obtained. Similarly, the carbon nanotubes 72 and the electrode portion 24 are disposed as in the second embodiment, and the thick portion 72a and the thin portion 72b are provided in the carbon nanotubes 72, so that the same effect as described above can be obtained.

In the first embodiment and the second embodiment, the automobile as the vehicle 50 equipped with the steering wheel 10 has been exemplified, but the present invention is not limited thereto. That is, the vehicle 50 equipped with the steering wheel 10 is not limited to the automobile, as long as the vehicle 50 is an object that carries a human, and may be another vehicle such as a ship or an aircraft.

What is claimed is:

1. A steering device mounted on a vehicle, the steering device comprising:
a grip portion gripped by a driver during steering;
a heater layer provided inside the grip portion, the heater layer including a flexible base material and carbon nanotubes that are supported on the base material and generate heat by energization; and
an electrode portion that energizes the carbon nanotubes,
wherein the carbon nanotubes on the base material include a plurality of openings.

2. The steering device according to claim 1, wherein the carbon nanotubes on the base material include a plurality of first linear portions extending linearly along a circumferential direction of the grip portion, and the plurality of first linear portions are arranged at intervals along a rotational direction of the grip portion to form the openings.

3. The steering device according to claim 2, wherein the carbon nanotubes on the base material include a plurality of second linear portions extending linearly along the rotational direction to intersect with the first linear portion, and the plurality of second linear portions are arranged at intervals along the circumferential direction to form the openings.

4. The steering device according to claim 1, wherein an anode and a cathode of the electrode portion are arranged alongside each other in the circumferential direction of the grip portion.

5. A steering device mounted on a vehicle, the steering device comprising:
a grip portion gripped by a driver during steering;
a heater layer provided inside the grip portion, the heater layer including a flexible base material and carbon nanotubes that are supported on the base material and generate heat by energization; and
an electrode portion that energizes the carbon nanotubes,
wherein the carbon nanotubes on the base material include a first region and a second region thinner than the first region.

6. The steering device according to claim 5, wherein the first region includes a plurality of first linear portions extending linearly along a circumferential direction of the grip portion, and the plurality of first linear portions are arranged at intervals along a rotational direction of the grip portion to sandwich the second region.

7. The steering device according to claim 6, wherein the first region includes a plurality of second linear portions extending linearly along the rotational direction to intersect with the first linear portion, and the plurality of second linear portions are arranged at intervals along the circumferential direction to sandwich the second region.

8. The steering device according to claim 4, wherein an anode and a cathode of the electrode portion are arranged alongside each other in the circumferential direction of the grip portion.
